(19) United States
(12) Patent Application Publication
(10) Pub. No.: US 2019/0383405 A1
(43) Pub. Date: Dec. 19, 2019

(54) HIGH PRESSURE VALVES

(71) Applicant: Quarter Turn Pressure Control, LLC, Midland, TX (US)

(72) Inventors: Travis Harrel, Midland, TX (US); Christian Leuchtenberg, Singapore (SG)

(21) Appl. No.: 16/012,600

(22) Filed: Jun. 19, 2018

(51) Int. Cl. F16K 3/36; F16K 5/22

(52) U.S. Cl. CPC F16K 3/36; F16K 5/22

(57) ABSTRACT

A high pressure valve having a valve body with a cylindrical bore and a movable member for selectively moving between an opened valve position for opening the cylindrical bore and a valve closed position for closing the cylindrical bore. An outer surface of the movable member exposed to the cylindrical bore in the valve closed position has a recess defined therein.

### FIELD OF INVENTION

This invention relates in general to fluid drilling equipment and in particular to high pressure valves subjected to severe operating conditions, such as the high pressures, high flow rates, and abrasive fluids commonly found in hydraulic fracturing operations and other oil and gas drilling applications.

### BACKGROUND OF INVENTION

Gate and plug valves internals, such as gates and plugs, have a service life that is limited by the condition of the sealing faces that are used to create a seal. While these parts are replaceable it is of interest to extend the life of these parts as best as possible under severe service conditions.

In one of the most severe service applications known today, hydraulic fracturing (“fracing”), very high pressure slurry is pumped through these valves at very high rates. In fracing, fracing slurry is forced down a wellbore with enough pressure to fracture the hydrocarbon bearing rock formations and force particulates into the resulting cracks. When the pressure is released, the particles (“proppant”), which may be sand or other high compressive strength additives such as ceramic particles and bauxite, remain in the fractures (cracks) and keep the fractures open. This “mechanism” then allows pathways for hydrocarbon to flow from the rock that was previously solid. The particle size distribution in these facing fluids is distributed so that the larger particles can prop open larger cracks and finer particles can prop open the very tips of the cracks, which are microscopic in nature. The particle sizes can vary from 0.004 inches to 0.01 inches (No 140 Mesh to No 8 Mesh). The pumping pressure at the valve can be up to 15,000 psi and the slurry velocity through a valve bore of 5.125 inches, as is typical of a 5⅛ inch, 15000 psi valve, is well above erosional velocity of about 50 to 70 feet per second. Moreover, the fracing is typically preceded and followed by an acid wash of 15% hydrochloric acid, which accelerates corrosion.

As one skilled in the art of mechanical engineering can ascertain, the fracing “mechanism” will inject proppant particles into any crack, orifice or possible leak path in the valve assembly. The injected particles remain in the valve assembly when the pressure is released. Small particles as large as 0.004 inches are within machining tolerances of steel parts and therefore will find their way into metal sealing surfaces. With the high velocity of abrasive fracing fluid, any weakness or point of turbulence can very quickly lead to a washout of a seal area or any interface. If an area or interface adjoins the valve main body, then the life of the main valve body is severely limited.

To preserve the main moving sealing parts and to allow them to seal effectively, very high viscosity sealing greases are injected and the valves (both gate and plug valves) are greased as many times as practicable on a job. Greasing forces the proppant out of the interfaces to allow effective sealing and prevent scouring of the seal surfaces with trapped particles. Even with this procedure, the moving sealing faces have a very limited service life and are replaced frequently.

Another, lesser appreciated cause of failure is the corrosion of the gate or plug face that is directly exposed to fracing or returning wellbore fluids when the valves are in a closed position. When the valves are in the open position, and this applies to both gate and plug valves, the sealing areas are protected from direct contact with fracing fluids by their position and by the action of sealing grease. The sealing faces that are used for the closed position are also protected by being positioned away from the main bore, and therefore away from direct contact with fracing fluids, as well as by being in a valve cavity filled with grease

A problem occurs when the valves, both gate and plug, are left in a closed position for extended periods. This is the situation for crown valves, the valve at the very top of a fracturing stack (an assembly of valves used for fracing), which are left closed for extended periods. Other valves, depending on the operation being carried out, can also be held in a closed position. Initially the face of the closed gate or plug that is directly exposed to the bore will have a very thin film of grease. However, under the severe service conditions explained earlier, this film of grease rapidly wears off and then the metallic face is exposed directly to the fracing or wellbore fluids or, in the case of a crown valve, one side is exposed to partially atmospheric conditions containing oxygen. Corrosion is accelerated as the acid washes associated with fracing remove any oxide films from the surface of the gate or plug exposed to the valve bore. Another type of valve that can commonly be closed for extended periods is the wellhead master valve, which is used when the well is being prepared for production after drilling.

Today, with the higher pressures and higher frac flowrates, larger valves are being constructed directly from the higher strength steels like 4340 and 17-4PH steel. This includes the internal components such as gates and plugs. These internal components are usually nitride treated to prevent corrosion and improve surface hardness. However, this nitride coating wears off rapidly and then corrosion can take place on the surface exposed to the main bore of the valve. Due to the short lifespan in general of the valves and their components used in fracing, more expensive surface treatments, including arc classing with Inconel or similar corrosion reducing materials is not a cost effective solution.

Once the nitride coating and/or grease film has gone, very rapid corrosion of the exposed metal surface takes place. This results in a dimensional expansion of the face due to the corrosion products, which are larger in volume than the base metal. When the valve eventually is opened, this raised and pocketed surface will gouge or score the sealing member against which the gate or plug is moving. This scraping action will also dislodge some of the raised corrosion particles leading to further scoring of both the sealing member and the moving member. In gate valves, the sealing member is usually the seat inserted into a valve pocket and the moving member is the gate, a slab of steel being displaced in a transverse motion. In a tapered plug valve, as usually used for fracing, the sealing member is an insert and the moving member is the plug which is displaced in a rotational motion. Both the transverse motion and rotational motion will shear any raised surface due the tight sealing tolerances and the particles or slivers created by this shear will further aggravate the problem.

Even a single opening movement after a bore face has corroded is enough to lead to failure of the sealing interface resulting downtime and interrupted operations while the damaged valve is repaired or replaced. The present inventive solution being presented allows for this problem to be eliminated on all valve types that have a surface exposed to the bore without having to resort to expensive corrosion resistant materials, overlays or inlays.

### SUMMARY OF INVENTION

One representative embodiment of the present inventive principles is a high pressure valve, which includes a movable sealing member and a sealing seat. The movable sealing member is modified in the exact area that is exposed to the valve bore when the movable sealing member is in the closed position. The area that is directly exposed to the bore is partially reduced in dimension compared to the principal dimension of the movable member. This dimensional reduction allows for the build-up of corrosion products to occur without the resultant dimensional growth extending above the main dimension of the movable member. This dimensional reduction will be referred to as a dimple in the movable sealing member.

Advantageously, a corrosion resistant coating coating can be placed in the dimple to eliminate or reduce the corrosion rate and formation of corrosion products.

### BRIEF DESCRIPTION OF DRAWINGS

For a more complete understanding of the present invention, and the advantages thereof, reference is now made to the following descriptions taken in conjunction with the accompanying drawings, in which:

FIG. 1 is a schematic side cross-sectional view of a tapered insert type plug valve;

FIG. 2a is an isometric view of the plug as used in the plug valve of FIG. 1 and is presented to demonstrate the problem being solved by the principles of the present invention;

FIG. 2b is a cross section view of the same plug as in FIG. 2a;

FIG. 3a is a schematic side view of plug that has been modified according to the invention;

FIG. 3b is a cross-section of the plug in FIG. 3a;

FIG. 4 is a schematic side cross-sectional view of a gate valve;

FIG. 5 is an isometric view of a gate as used in the gate valve of FIG. 4 used to demonstrate the problem being solved by the principles of the present invention;

FIG. 6a is a schematic side view of gate that has been modified according to the invention; and

FIG. 6b is a cross-section of the gate in FIG. 6a.

### DETAILED DESCRIPTION OF THE INVENTION

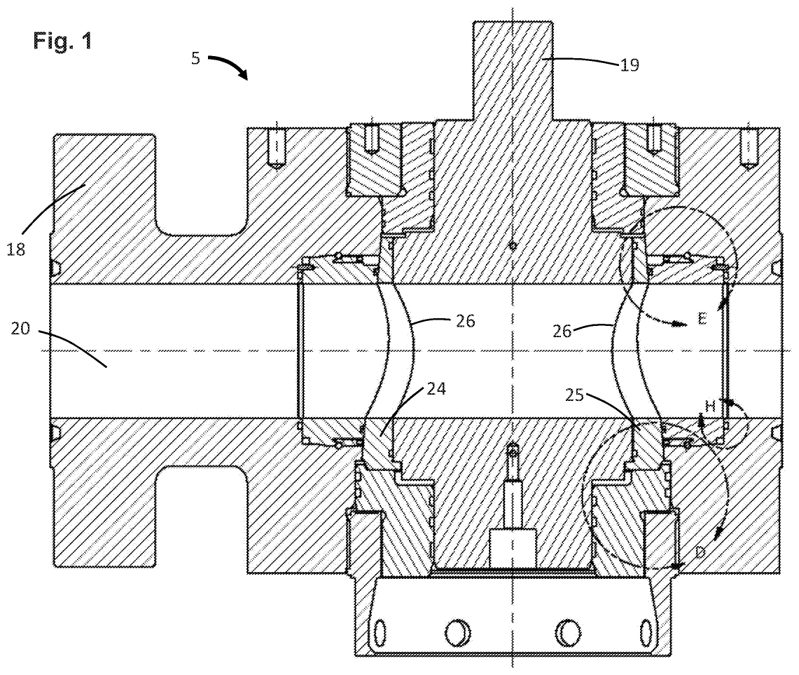

The problems being solved and the solutions provided by the embodiments of the principles of the present invention are best understood by referring to FIGS. 1 to 6 of the drawings, in which like numbers designate like parts.

FIG. 1 is a schematic side cross-sectional view of a tapered insert type plug valve 5 that has a body 18 with a valve bore 20. A plug 19 rotationally moves with respect to two stationary identical sealing inserts 24, 25 across interface 26.

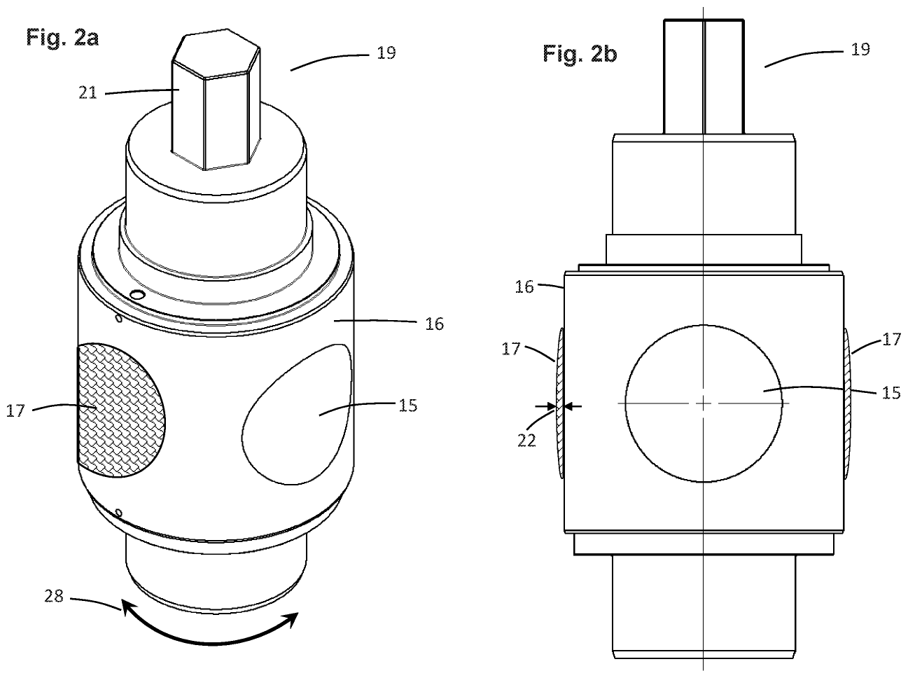

FIG. 2a is an isometric view of the plug 19 as used in the plug valve 5 of FIG. 1.

The plug 19 can be rotated to open and close over ninety degrees, as indicated by the arrow 28, when turning the shaft 21. The plug 19 has a bore through 15 that allows fluid flow when the valve is open. Cylindrical face 16 of the plug 19 is an exactly finished dimensioned cylinder that rotates with respect to the inserts 24, 25 (FIG. 1) with direct metal contact aided by sealing grease. When the valve is closed by a quarter turn rotation of the plug 19, then part of the cylindrical face 16 is now exposed to the valve bore 20, as indicated by circular area 17. This area 17 is subject to corrosion, and as this occurs, the volume of area 17 expands beyond the tightly controlled sealing face 16 dimension. This is due to the fact that the volume of corrosion products is more than the original volume of steel. This can be better seen in FIG. 2b, which is a cross-sectional view of the same plug as in FIG. 2a, taken across the plug bore 15.

Looking down the plug bore 15 in FIG. 2b, an increased material volume due to corrosion on area 17 causes area 17 to bulge beyond the fixed sealing diameter face 16. When the plug 19 is rotated back into open position, this increased dimension 22, as indicated by the arrows, interferes with the sealing interface 26 (FIG. 1) and gouges, tears or scratches the inserts 24, 25 and/or the face 16 of the plug 19. This causes the failure of the metal to metal seal and therefore leads to pre-mature valve repair or replacement during a job or after a job during maintenance. The inventive step presented next is the solution to this problem.

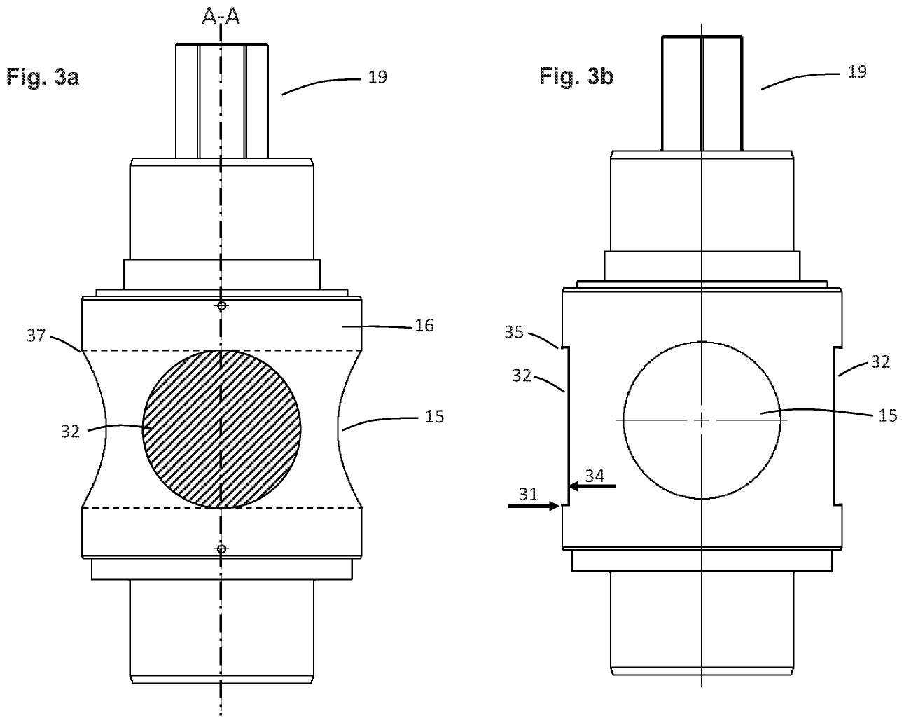

FIG. 3a is a schematic side view of plug that has been modified according to the invention. FIG. 3a shows the face that is presented to the valve bore 20 when the valve is closed. Circular area 32 is of diameter exactly equivalent to the diameter of the plug bore 15, which is the same as the valve bore 20 (FIG. 1). In this shaded area, a small amount of plug material has been removed to a constant depth by machining with respect to cylindrical plug face 16 to form dimples (recesses) 32 on opposite sides of the plug. This can be more clearly seen in FIG. 3b, which is a cross-section at A-A of the plug in FIG. 3a. In the cross-section of FIG. 3b, looking down the plug bore 15, the machined dimples (recesses) 32 are disposed on the sides of the plug 19. The circumferential edge 35 has the same edge treatment as the circumferential edge 37 of the plug bore 15, which has a very slight taper to avoid a sharp edge with machining swarf. The depth of the dimples 32, as indicated by arrows 31 and 34, is preferably around 0.04 to 0.12 inches.

Machining the recessed dimples 32 in the surface 16 of the plug 19 during manufacture has distinct advantages. First, the usual nitride surface hardening and anticorrosion treatment, applied after machining, is now situated in a recess that cannot be scraped or polished during the movement occurring from valve operations. This keeps the nitride anticorrosion treatment intact when the valve is in the closed position thus preventing the occurrence of corrosion. Secondly the recessed dimples 32 can have additional anticorrosion coatings applied, which will stay in place, given that surface of the dimples 32 will never touch the inserts 24, 25 during the operation of the valve. Third, the dimples 32 will fill with sealing grease when the valve is in open position and has been greased. Then, when the valve is closed, instead of a very thin grease film, there is now a thick coating of grease having thickness equivalent to the depth of the dimple recess, which will act as a substantial corrosion barrier.

The internal surfaces of the dimples 32, both the base and the side walls can be coated with other types of corrosion inhibiting coatings and materials like paint, other surface coatings, surface penetration treatments similar to nitriding, arc inlays, laser inlays and other such methods suited for the base material of the plug. The dimples 32 can also be completely filled with another material and machined or polished back to the main sealing dimension of the plug. This material can be attached by gluing, screwing, welding or another attachment process. This method of improvement can also be applied to a gate valve or for that matter to any valve that has a constant dimension across the moving sealing member e.g. a ball in a ball valve.

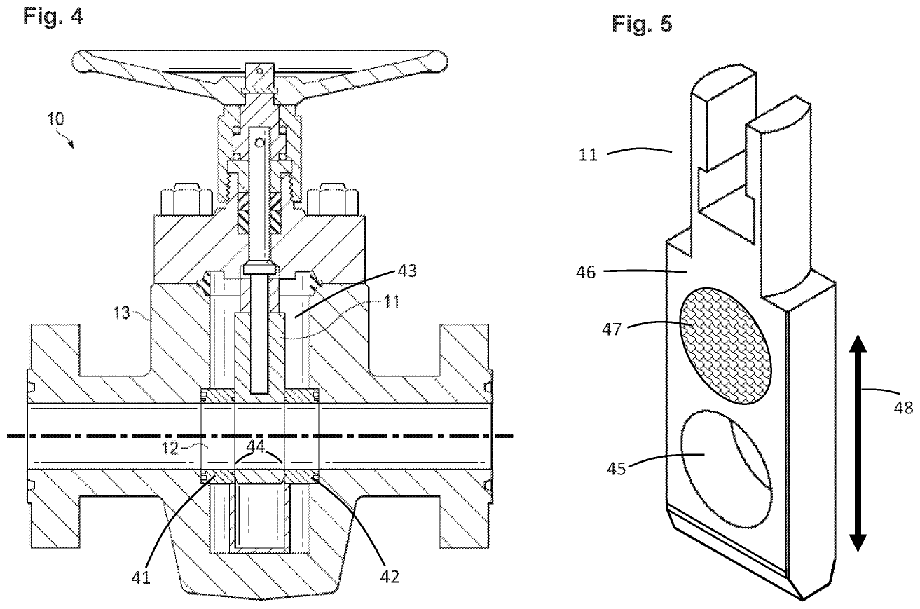

FIG. 4 is a schematic side cross-sectional view of a gate valve 10 with a body 13 and a valve bore 12 A moving gate 11 slides across two sealing inserts 41, 42 having sealing interfaces 44 with respect to the gate 11.

FIG. 5 is an isometric view of a gate as used in the gate valve of FIG. 4, showing a gate 11 that can move in a transverse motion 48 along the sealing inserts 41, 42. The gate 11 has a bore 45, which if placed concentrically across the inserts 41, 42, puts the valve 10 in an open position. Then, the rest of the gate 11, the upper part, is in the valve cavity 43 and protected by the grease in the cavity. If the gate 11 is closed by moving it in a downward motion, then the area 47 is exposed to the gate valve bore 12. This area 47 is of the exact same diameter as the gate bore 45 and the valve bore 12.

Once the grease wears off this face 47, rapid corrosion occurs and the area 47 grows in dimension beyond the controlled gate width dimension of face 46, very similar to the cross-section shown for the plug valve in FIG. 2b, except that it occurs on a flat face. When the gate valve 11 is opened, this raised section 47 jams across the sealing interfaces faces 44 leading to gouging, scratching and debris contamination of the sealing interfaces 44. This damages the gate 11 and/or the inserts 41 and 42 leading to valve repair or replacement, as already discussed earlier. The solution here is in principle the same as the one embodied for the plug valve as illustrated next.

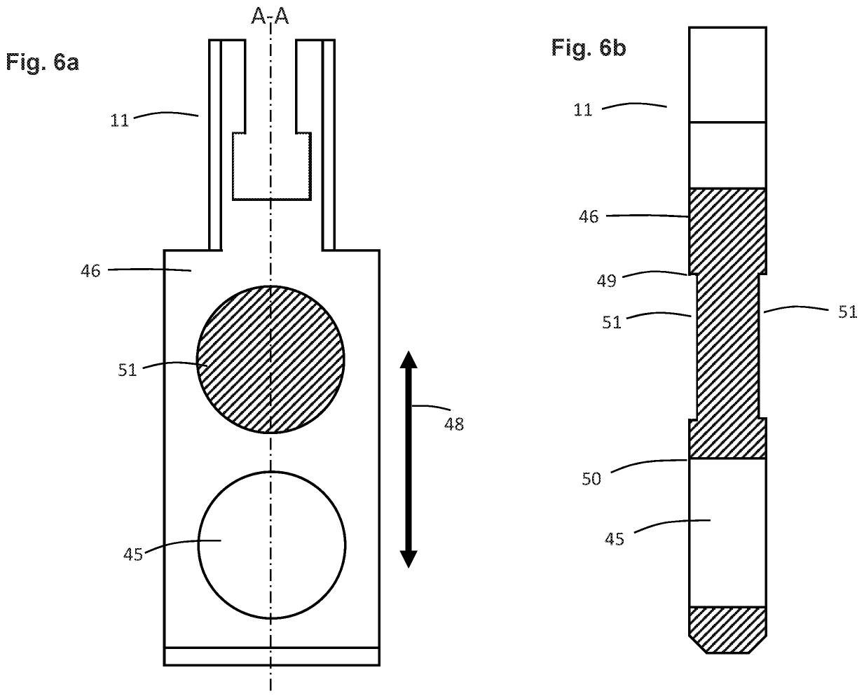

FIG. 6a is a schematic side view of gate 11 that has been modified according to the invention. The gate 11 has a controlled dimension of face 46. Into this face have been machined dimples (recesses) 51, which have the same diameter as the gate bore 45 and are in the exact alignment position with the valve bore 12 when the gate 11, and hence the gate valve 10, is closed. The transverse movement of the gate is indicated by arrow 48.

This modification can be seen more clearly in FIG. 6b which is a cross-section at A-A of the gate 11 in FIG. 6a. The dimples 51 on either side of the gate are recessed enough to allow corrosion products not to exceed the exact dimensions of face 46. The circumferential edges 49 of the dimples 51 receive the same edge treatment as the circumferential edges 50 of the gate bore 45. Any corrosion treatment will now be in a mechanically safe area within the dimples 51. Further anti corrosion coatings can be applied in this area, as well as fillings, as discussed earlier for the plug valve embodiment of the principles of the present invention.

In sum, the principles of the present invention provide a very cost effective method for preventing failure of high pressure valves due to corrosion of valve faces when in the closed position. While these principles have been described in conjunction with high pressure gate and plug valves, they can be suitably applied to all valves that have a controlled dimension moving member moving relative to a stationary sealing member. (For purposes of the present disclosure, a stationary sealing member does not move in the same plane as a movable member, although there may be very small movements of the stationary member at right angles to the movable member due to seal flex.) Furthermore, even though the description above is for circular and cylindrical valve bores, the present inventive principles are also applicable to other valve bore shapes (e.g. in tapered plug valves, which present a modified trapezoidal cross-section on a tapered plug interface).

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

What is claimed is:

1. A high pressure valve comprising:
a valve body having a cylindrical bore; and
a movable member for selectively moving between an opened valve position opening the cylindrical bore and a valve closed position closing the cylindrical bore, an outer surface of the movable member exposed to the cylindrical bore in the valve closed position having a cylindrical recess defined therein.

2. The high pressure valve of claim 1, wherein the cylindrical bore has a circumference and the cylindrical recess has a substantially equal circumference wherein the cylindrical bore and the cylindrical recess are substantially concentric in the valve closed position.

3. The high pressure valve of claim 1, wherein cylindrical recess is adapted to receive grease from within the valve body in the valve opened position.

4. The high pressure valve of claim 1, wherein the movable member comprises a gate.

5. The high pressure valve of claim 1, wherein the movable member comprises a plug.

6. The high pressure valve of claim 1, wherein the movable member comprises a ball.

7. The high pressure valve of claim 1, wherein a surface of the cylindrical recess has been treated with an anti-corrosion treatment.

8. The high pressure valve of claim 7, wherein the anti-corrosion treatment is a selected one of a surface coating, a surface penetration treatment, a weld inlay, or a laser inlay.

9. The high pressure valve of claim 2, wherein an edge around the circumference of the cylindrical bore and an edge around the circumference of the cylindrical recess of the movable member have both been treated with a selected anti-corrosion treatment.

10. The high pressure valve of claim 1, wherein the cylindrical recess is substantially filled with a material such that a surface of the material is substantially flush with a surface of a surrounding sealing surface of the movable member.

11. The high pressure valve of claim 1, wherein a depth of the cylindrical recess is sufficient to accommodate products of corrosion without exceeding a sealing dimension of an outer surface of the movable member.

12. A movable member adapted for use in a high pressure valve comprising:
a body adapted to selectively open and close a bore of a high pressure valve, an outer surface of the body adapted to be exposed to the cylindrical bore in a valve closed position having a recess defined therein.

13. The movable member of claim 12, wherein the body is adapted to traverse the bore of a high pressure gate valve.

14. The movable member of claim 12, wherein the body is adapted to rotate within the body of a high pressure plug or ball valve.

15. The movable member of claim 12, wherein a depth of the recess is selected to be sufficient to accommodate products of corrosion without exceeding a dimension of a sealing surface of the body of the movable member.

16. The movable member of claim 12, wherein a surface of the recess has been treated with an anti-corrosion treatment.

17. The movable member of claim 15, wherein the anti-corrosion treatment is a selected one of a surface coating, a surface penetration treatment, a weld inlay, or a laser inlay.

18. The movable member of claim 12, wherein an edge around a periphery of the recess of the movable member has been treated with a selected anti-corrosion treatment.

19. The movable member of claim 12, wherein the recess is substantially filled with a material such that a surface of the material is substantially flush with a surface of a surrounding sealing surface of the movable member.

20. A movable member adapted for use in a high pressure valve comprising:
a body adapted to selectively open and close a bore of a high pressure valve, an outer surface of the body adapted to be exposed to the bore in a valve closed position having a recess defined therein.

21. The movable member of claim 20, wherein the body is adapted to rotate within the body of a high pressure ball valve.

22. The movable member of claim 20, wherein a depth of the recess is selected to be sufficient to accommodate products of corrosion without exceeding a dimension of a sealing surface of the body of the movable member.

23. The movable member of claim 20, wherein a surface of the recess has been treated with an anti-corrosion treatment.

24. The movable member of claim 25, wherein the anti-corrosion treatment is a selected one of a surface coating, a surface penetration treatment, a weld inlay, or a laser inlay.

25. The movable member of claim 20, wherein an edge around a periphery of the recess of the movable member has been treated with a selected anti-corrosion treatment.

26. The movable member of claim 20, wherein the recess is substantially filled with a material such that a surface of the material is substantially flush with a surface of a surrounding sealing surface of the movable member.
